(19) United States
(12) Patent Application Publication
(10) Pub. No.: US 2017/0372646 A1
(43) Pub. Date: Dec. 28, 2017

(54) Display System and Apparatus with Directional Emission

(71) Applicant: Nanolumens Acquisition, Inc., Norcross, GA (US)

(72) Inventors: Richard C. Cope, Duluth, GA (US); Edward Buckley, Melrose, MA (US); Jorge Perez-Bravo, Alpharetta, GA (US)

(73) Assignee: Nanolumens Acquisition, Inc., Norcross, GA (US)

(21) Appl. No.: 15/630,233

(22) Filed: Jun. 22, 2017

Related U.S. Application Data
(60) Provisional application No. 62/353,556, filed on Jun. 23, 2016.

(51) Int. Cl. G09F 9/302; G02B 3/00; H05B 33/12

(52) U.S. Cl. CPC G09F 9/302; H05B 33/12; G02B 3/00; G02B 3/0006

(57) ABSTRACT

Disclosed are embodiments of display systems that provide directional emission from light emitting elements. The light emissive display systems disclosed provide methods and apparatus for controlling the direction and intensity of light emitted by the display. Display modules have a plurality of light emitting elements arranged in a predetermined pattern and providing a highly uniform visual effect. Arrangement of physical and optical components with respect to the position and orientation of light emitting devices collectively steers the light from the display with a controlled directionality and intensity.

### CROSS REFERENCE TO RELATED APPLICATIONS

This application claims the benefit of prior filed provisional Application No. 62/353,556, entitled “Display System and Apparatus with Directional Emission”, filed Jun. 23, 2016. Application 62/353,556 is herein incorporated by reference.

### STATEMENT REGARDING FEDERALLY SPONSORED RESEARCH OR DEVELOPMENT

Not Applicable.

### DESCRIPTION OF ATTACHED APPENDIX

An additional 15 sheets of drawings are submitted in a separate appendix to the present disclosure.

### BACKGROUND

A large scale visual display system is a particularly compelling way for people to experience the presentation of visual information. Such systems are the focus of the present disclosure.

There are numerous features of a visual display system that contribute to its impact upon viewers including: size, brightness, gray scale performance, contrast, color saturation, color depth, display refresh rate, resolution, pixel pitch, pixel pitch uniformity, and others.

There are numerous other features of a visual display system that are of interest to the owners and operators of such systems including: ease of installation, ease of service, reliability, ease of configuration, ease of maintenance, ease of operation, cost of the system, cost of installation, cost of operation, cost of service, and others.

Display systems with large screen sizes present a number of difficult problems that are in need of solution. A typical mounting environment for a large display is an elevated position situated such that the expected viewers are below, and often well below, the viewing plane of the display screen. It is typical that the viewers of such systems are seated or standing or walking some distance below the midpoint of the display. Any light that does not reach a single viewer may contribute to light pollution. The typical large visual display emits light in a more or less symmetric pattern from the front of the display, thereby emitting a lot of light that never reaches a viewer. It is therefor desirable to reduce the amount of light pollution emitted by a display.

Another difficult problem in need of solution relates to the energy efficiency of a display measured with respect to the intensity of light received by a viewer of a display. Viewers typically prefer bright displays. Greater brightness typically requires more power. Light produced by a display that does not reach a single viewer is therefor wasted power. Hence it is desirable to maximize the light reaching viewers while at the same time reducing the amount of light that not reaching the viewers of the display.

In consideration of the foregoing points, it is clear that embodiments of the present disclosure confer numerous advantages and are therefore highly desirable.

### BRIEF DESCRIPTION OF THE DRAWINGS

These and other features, aspects, and advantages of the present invention will become better understood with regard to the following description, appended claims, and accompanying drawings where:

FIG. 1A shows a square consistent with a regular four sided polygon.

FIG. 1B shows a square tiling of a two dimensional plane

FIG. 1C shows coordinate axis defined on square tiling. Enlarged view 1D is indicated

FIG. 1D shows an enlarged view of the indicated region of FIG. 1C showing uniform row and column pitch distance.

FIG. 1E shows a plan view of a display module having a plurality of light emitting elements coordinate axis defined on square tiling.

FIG. 1F shows the display module of FIG. 1E overlaid with the predetermined pattern of square tiling and coordinate axes.

FIG. 1G shows a plan view of two display modules aligned along their y-axis.

FIG. 1H shows a plan view of two display modules aligned along their x-axis.

FIG. 2A shows a perspective view of a display system and apparatus with directional emission according to an embodiment of the present disclosure. Cross-sectional view 2B is indicated.

FIG. 2B shows a cross sectional view of the system of FIG. 2A with coordinate system indicated

FIG. 3A is a cross-sectional view of a light emitting element without any directional emission features. Vertical axis Y-Y is shown.

FIG. 3B is a plan view of the light emitting element of FIG. 3A, both horizontal axis X-X and vertical axis Y-Y being shown. It is noted that the light emitting element of FIG. 3A has no directional emission features.

FIG. 3C is a chart showing relative illuminance versus radiation angle of a the light emitting element of FIG. 3A and FIG. 3B with respect to the far field emission pattern (FFEP). Relative illuminance with respect to axis X-X and relative illuminance with respect to axis Y-Y are shown. It is noted that the absence of directional emission features in the embodiments of FIG. 3A and FIG. 3B result in symmetric FFEP with respect to radiation angle 0 degrees for both the axis Y-Y and axis X-X.

FIG. 4A shows a schematic cross sectional view of a light emitting element comprising a plurality of individual light emitters.

FIG. 4B-FIG. 4E show schematic cross sectional views of various embodiments of a light emitting element comprising a plurality of individual light emitters and having directional emission features.

FIG. 5A is a chart showing relative illuminance versus radiation angle of a representative light emitting element of the present disclosure having directional emission features. Directional emission features are shown by the chart to result in an asymmetric FFEP along the axis Y-Y while maintaining a substantially symmetric FFEP along the axis X-X. It can be seen that the radiation angle of peak emission is not at 0 degrees.

FIG. 5B is a chart showing relative illuminance versus radiation angle of a representative light emitting element of the present disclosure having directional emission features. Directional emission features are shown by the chart to result in an FFEP along the axis Y-Y having a narrower radiation angle range than a light emitting element without directional emission features.

FIG. 5C is a chart showing relative illuminance versus radiation angle of a representative light emitting element of the present disclosure having directional emission and light gain features. Directional emission features are shown by the chart to result in an asymmetric FFEP along axis Y-Y while maintaining a substantially symmetric FFEP along axis X-X. In addition, and as indicated by the chart of FIG. 5C, the FFEP with respect to axis Y-Y is confined to a narrower angular range than FFEP with respect to axis Y-Y of chart of FIG. 5B.

FIG. 6A-6B show schematic cross sectional views of various embodiments of a light emitting element comprising a plurality of individual light emitters and having directional emission features.

FIG. 6C shows a cross sectional view of an embodiment having a plurality of light emitting elements, the plurality collectively having directional emission features. The FFEP of the plurality of light emitting devices is a composite of the FFEP of the individual light emitting elements.

FIG. 7A-7B are cross sectional views showing various embodiments of a light emitting element having a lens element optically coupled to one or more light emitting devices and providing directional emission with light gain over a range of radiation angles.

FIG. 7C shows the embodiment of FIG. 7B in which an angled substrate physically coupled to the light emitting element tilts the element and thereby provides directional emission. It can be recognized that an angled substrate can be used in conjunction with other embodiments of the present disclosure to provide directional emission.

FIG. 8 shows an embodiment in which the angled surface of an optical material provides directional emission to the light emitting element.

FIG. 9A-9B are cross sectional views showing a micro lens array optically coupled to the light emitting element and providing directional emission with light gain over a range of radiation angles. The embodiment of FIG. 9B has and angled substrate feature that is effective providing directional emission.

FIG. 10A-10C shows various embodiments in which one or more prismatic elements in an array are optically coupled to the light emitting elements and are effective for confining the emitted light to a more narrow range, thereby providing directional emission with light gain.

FIG. 11A-11C shows various embodiments in which one or more total-internal-reflection (TIR) lens elements in an array are optically coupled to the light emitting elements and are effective for confining the emitted light to a more narrow range, thereby providing directional emission with light gain.

FIG. 12A-12C shows various embodiments in which one or more asymmetric pentagonal lens elements in an array are optically coupled to the light emitting elements and are effective for both confining the emitted light to a more narrow range and changing the direction of peak emission, thereby providing directional emission with light gain.

### LIST OF REFERENCE NUMBERS APPEARING IN THE FIGS

2—display system with directional emission
6—display control system
8—coordinate system showing x-axis, y-axis, and z-axis
8X—x-axis
8Y—y-axis
8Z—z-axis
10—square tile, which is a regular 4 sided polygon
10a, 10b, etc.—first square, second square, etc.
11—pitch distance
12—square tiling of the plane
12v—representative vertex of the square tiling
12s—representative side of the square tiling
14—predetermined pattern corresponding to a tiling of the plane
16—rectangular tiling of the plane
23—visual media data
28—visual media rendered on the viewing plane of the display
29X—far field emission pattern with respect to a defined x-axis or X-X axis
29Y—far field emission pattern with respect to a defined y-axis or Y-Y axis
40—lens shaped optical material
41—optical material
42—microlens array
44—array of prismatic optical elements
46—array of TIR optical elements
48—array of asymmetric pentagonal prismatic elements
50—incidence vector
50a, 50b, . . . —first, second, etc. incidence vector
52—viewpoint
60—substrate
62—aperture
62a, 62b, . . . —first, second, etc. aperture
64—bottom surface
66—wall surface
66a, 66b, . . . —first, second, etc. wall surface
68—optical coating
68a, 68b, . . . —first, second, etc. optical coating
69—light emitting device
69a, 69b, . . . —first, second, etc. light emitting device
70—display module
70a, 70b, 70c etc.—first, second, third, etc. display module
71—light emitting element
71a, 71b, etc.—first, second, etc. light emitting element
72—plurality of light emitting elements
74—display plane
80—viewing plane
82—surface normal vector
83—horizon vector
84—luminous output in the direction of peak emissions
84a, 84b, . . . —first, second, etc. luminous output

### DESCRIPTION

The present disclosure is directed to systems, methods, and apparatus to provide display systems and display modules with directional emission of light, thereby reducing light pollution and improving the power efficiency of said systems and modules.

Display systems of the present disclosure comprise a plurality of display modules assembled onto a support frame to make a large, unified, visual display. Each display module in the system comprises a plurality of light emitting elements coupled to a support structure and arranged in a predetermined pattern with respect to a display plane. Each display module is shaped so that it may abut one or more other display modules without introducing gaps or overlaps between adjacent display modules. The display systems disclosed create a highly uniform visual effect by creating highly uniform spacing between light emitting elements, both within a single display module and across a plurality of display modules when the plurality are assembled into a large, unified, visual display. Complementary alignment features cooperatively enforce alignment between adjacent display modules thereby maintaining highly uniform spacing of light emitting elements throughout the plurality of assembled display modules.

Features of the present disclosure provide control over the direction of emission of light from the display. Other features of the disclosure provide control over the intensity of emission of light from the display, providing gain in some ranges and diminution in other ranges. The disclosed feature may be used singly or in combination to provide a variety of beneficial properties to a display system or display module. Each display module provides a plurality of light emitting elements arranged on a display plane. After assembly, the plurality of display modules collectively create a viewing plane that may be viewed by the viewing public. In general, light output from a light emitting element has a detailed description involving radiated illuminance with respect to solid angle projecting from the light emitting device into 3 dimensional space. In some embodiments of the disclosure directional emission is described in terms of the far field emission pattern (FFEP) of optical power emitted by the display as a composite of the far field emission pattern of the plurality of light emitting elements comprising the display. In other embodiments directional emission is described in terms of the far field emission pattern of optical power emitted by individual light emitting elements or groups of light emitting elements.

For the purposes of understanding the FFEP properties of either a plurality of light emitters or an individual light emitter, a surface normal vector may be defined that points in the direction that is perpendicular to the viewing plane of the display. In relation to the surface normal vector, a horizontal dimension may be defined along a lateral or side-to-side direction while a vertical dimension may be defined along an up-and-down direction. To a person who is standing or sitting while viewing the viewing plane, the horizontal dimension corresponds to left and right while the vertical dimension corresponds to up and down.

The embodiments disclosed provide advantageous effects which may be used singly or in combination to provide display systems and/or apparatus with control over directional emission. With reference now to the surface normal vector, which may be defined as a vector that is perpendicular to the viewing plane of the display, the advantageous effects achieved by the embodiments comprise: 1) Directing the peak emission intensity of the vertical FFEP in a direction other than parallel to the surface normal vector while the horizontal FFEP remains substantially symmetric with respect to the surface normal vector; 2) Directing a substantial portion of the vertical FFEP of the light emitting element in a direction other than parallel to the surface normal vector; 3) Confining the radiated illuminance of the vertical FFEP to a narrower angular range as compared to the unaffected or unmodified light emitting device; and, 4) Providing optical gain to the vertical FFEP as compared to the unaffected light emitting device.

In an exemplary embodiment, a light emitting display system comprises:

a plurality of light emitting elements arranged in a predetermined pattern collectively defining a viewing plane; each of said plurality of light emitting elements comprising:

at least one light emitting device having a first far field emission pattern of optical power, the light emitting device producing emitted light; said first far field emission pattern having a first direction along which a first peak intensity of optical power of said first far field emission pattern propagates;

an optical element optically coupled to said light emitting device, at least a portion of said emitted light passing through said optical element, said optical element operative to transform said first far field emission pattern into a second far field emission pattern of optical power, said second far field emission pattern having a second direction along which a second peak intensity of optical power of said second far field emission pattern propagates;

further characterized in that said first direction and said second direction are not parallel;

further characterized in that said second peak intensity is higher than said first peak intensity;

said plurality of light emitting elements collectively creating, by superposition of each of said second far field emission patterns, a third far field emission pattern of optical power emitted by the light emitting display system, said third far field emission pattern having a third direction along which a third peak intensity of optical power of said third far field emission pattern propagates;

the viewing plane further defining a surface normal vector that is perpendicular to said viewing plane;

the system further characterized in that said third direction and said surface normal vector are not parallel.

In another exemplary embodiment the system may be further characterized in that: a horizon vector is defined originating at the geometric centroid of the viewing plane and directed toward the horizon; said third direction is in a direction that is below the horizon.

In another exemplary embodiment the system may be further characterized in that: the third far field emission pattern has a left-right mirror symmetry with respect to a vertical plane defined perpendicular to the viewing plane and passing through the geometric centroid of the viewing plane.

In another exemplary embodiment the system may be further characterized in that: the third far field emission pattern does not have up-down mirror symmetry with respect to a horizontal plane defined perpendicular to the viewing plane and passing through the geometric centroid of the viewing plane.

To make the description more precise, it is useful to consider a three dimensional Cartesian coordinate system consisting of mutually orthogonal axes x, y, and z. The x-y plane is identified as being parallel to the viewing plane, and the z axis is in a direction perpendicular to the viewing plane. In the reference frame of a person viewing the display, the x axis may be considered as extending to the left and right while the y axis may be considered as extending up and down. The z axis, being perpendicular to the viewing plane, is parallel to the surface normal vector referenced above in connection with the FFEP and radiated illuminance properties of light emitting elements.

Tesselation of a planar surface is the tiling of the plane using one or more geometric shapes, called tiles, creating no gaps and no overlaps. A periodic tiling has a repeated geometric pattern. A regular tiling is a tiling in which all tiles are regular polygons having the same size and shape. Square, triangular, and hexagonal tilings are each an example of a regular, periodic tiling that can achieve a tesselation of a planar surface without gaps or overlaps. Tilings are of special interest in the construction of modular displays because their properties enable the construction of large displays with desirable properties. Assembling a plurality of smaller display modules in which each display module is configured to have a size, shape, and orientation corresponding to a predetermined tiling may produce a large display having no gaps and no overlaps between adjacent display modules.

Within a single display module, a plurality of light emitting elements may be arranged in a predetermined pattern derived from an appropriately configured tiling. A planar tiling of regular polygons consists of edges and vertexes. The set of vertexes of a regular polygon tiling can be seen to create a pattern with a high degree of regularity. A highly uniform visual effect may be produced by placing a light emitting element at or about each of the vertexes of a regular polygon tiling.

In creating a uniform visual effect, it is useful to consider a property called pitch distance, which is the distance between any light emitting element and its closest adjacent light emitting elements. It can be seen that a highly uniform visual effect is produced by maintaining a highly uniform pitch throughout a single display module and across a plurality of adjacent display modules. Preferred embodiments of the present disclosure use light emitting elements located at or about the vertexes of a regular polygon tiling. A regular square tiling is one such preferred tiling, producing a uniform visual effect by providing uniform spacing between both rows and columns of light emitting elements. The spacing between adjacent rows and between adjacent columns of a regular square tiling may be referred to as the pitch of that pattern. In such a square tiling, it can be seen that any light emitting element will have at least two closest adjacent neighboring elements that are spaced apart from each other by a distance close to or substantially equal to the pitch distance.

In addition to uniform pitch within a single display module, the spacing between display modules can be controlled so that uniform pitch of light emitting elements is maintained across a plurality of assembled display modules. A preferred embodiment is to provide a display module with a perimeter region, of a predetermined width, that contains no light emitting elements. The preferred width of the perimeter region is less than or about equal to one half of the pitch distance, when measured inward and along the edges of the regular polygon tiling defining the location of the plurality of the light emitting elements. When two display modules are assembled adjacent to one another, each module may provide a perimeter region width of about one half of the pitch, which cumulatively creates a pattern of uniform pitch spanning both modules. A plurality of display modules may thereby be assembled to create uniform pitch spanning the plurality of display modules.

A single display module may comprise a plurality of light emitting elements coupled to a substrate, and arranged in a predetermined pattern corresponding to the vertexes of a regular polygon tiling. The display module has a perimeter. A plurality of display modules may be assembled such that a portion of the perimeter of each display module abuts a portion of the perimeter of at least one other display module, each module positioned to maintain uniform pitch spacing across the plurality of display modules.

A display system according to the present disclosure may be constructed by assembling a plurality of display modules onto a support frame, the support frame having been previously.

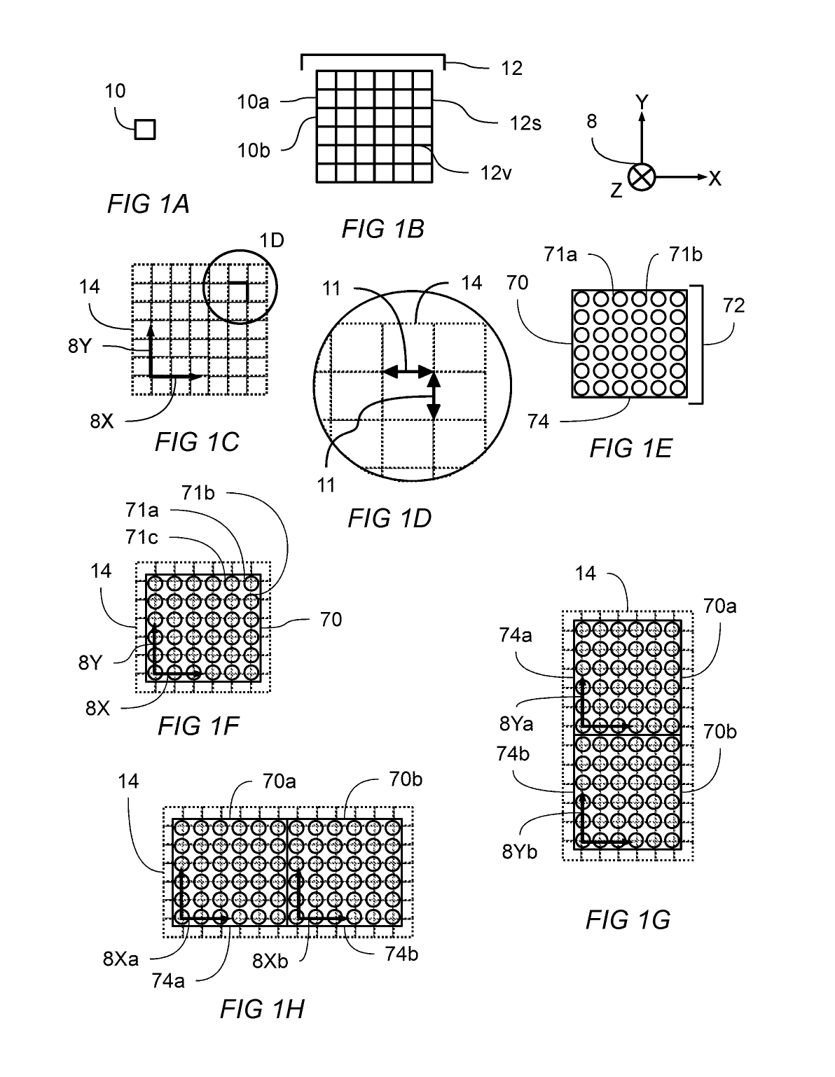

Turning now to FIG. 1A, shown is a regular four sided polygon, also called a square 10, consistent with the square tiling 12 of the two dimensional plane shown in FIG. 1B. A coordinate system 8 is indicated so as to make discussion of geometry features of the present disclosure more clear. Square tiling 12 is comprised of a plurality of square tiles, of which first square 10a and second square 10b are typical, arranged so that no gaps and no overlaps are produced. When arranged into the predetermined pattern shown in FIG. 1B, the square tiling 12 can be seen to create a plurality of vertex 12v and a plurality of side 12s, in which every vertex 12v is separated a distance of about 12s from each of its closest neighboring vertexes.

FIG. 1C shows predetermined pattern corresponding to a tiling of the plane 14 according to a square tiling. Overlaid onto the predetermined pattern corresponding to a tiling of the plane 14 are x-axis 8X and y-axis 8Y, showing that a coordinate system can be overlaid onto the predetermined pattern to facilitate clear disclosure of the location and alignment of other features to be described. The enlarged section, denoted FIG. 1D, shows that the square tiling of the plane gives rise to a highly uniform spacing of vertexes, which can be characterized as pitch distance 11. Pitch distance 11 corresponding to the predetermined pattern 14 gives rise to uniform spacing between rows and columns when that predetermined pattern is based upon a square tiling. It can be seen that row spacing and column spacing are both about equal to the pitch distance 11.

Turning now to FIG. 1E, shown is a display module 70 having a plurality of light emitting elements 72, of which first light emitting element 71a and second light emitting element 71b are individual members of the plurality. Plurality of light emitting elements 72 is shown arranged according to a predetermined pattern so as to create a highly uniform visual effect upon display plane 74. FIG. 1F shows how predetermined pattern 14 according to a square tiling of the plane may be used to position individual light emitting elements 71a, 71b, and 71c according to the location of the vertexes of said predetermined pattern 14. Superimposed upon the plurality of light emitting elements are x-axis 8X and y-axis 8Y. The display module 70 of FIG. 1F comprises a plurality of light emitting elements, each of which may be a single light emitting device or multiple light emitting devices. A preferred light emitting element combines red, blue, and green light emitting devices within one light emitting element so as to provide full color spectrum display. Monochrome and other combinations of devices may be used still within the spirit and scope of this disclosure. The display modules of FIG. 1E and FIG. 1F each have a region adjacent to their perimeter that is free from light emitting elements. This enables close spacing of adjacent modules as will be seen now.

FIG. 1G shows a first display module 70a adjacent to a second display module 70b and disposed so that their display planes 74a and 74b abut and their respective y-axes 8Ya and 8Yb are substantially aligned, thereby creating a highly uniform visual effect that spans the combined display modules. A pitch distance can be defined between adjacent light emitting elements between adjacent display modules that is substantially equal to the pitch distance between adjacent light emitting elements within a single display module.

FIG. 1H shows a first display module 70a adjacent to a second display module 70b and disposed so that their respective display planes 74a and 74b abut and their respective x-axes 8Xa and 8Xb are substantially aligned, thereby creating a highly uniform visual effect that spans the combined display modules. A pitch distance can be defined between adjacent light emitting elements between adjacent display modules that is substantially equal to the pitch distance between adjacent light emitting elements within a single display module. When abutted and aligned in the foregoing manner, two adjacent modules may be combined such that their combined plurality of light emitting elements are disposed upon a single predetermined pattern 14 defining a regular tiling of the plane.

FIG. 1G and FIG. 1H make it clear that a large display may be constructed from display modules designed according to the teaching of FIG. 1A-FIG. 1H. Such a large display will tile the two dimensional plane without gaps and without overlaps and produce a highly uniform visual effect. Any number of display modules may be combined in both x and y directions to make a large display that is substantially free from visual aberrations.

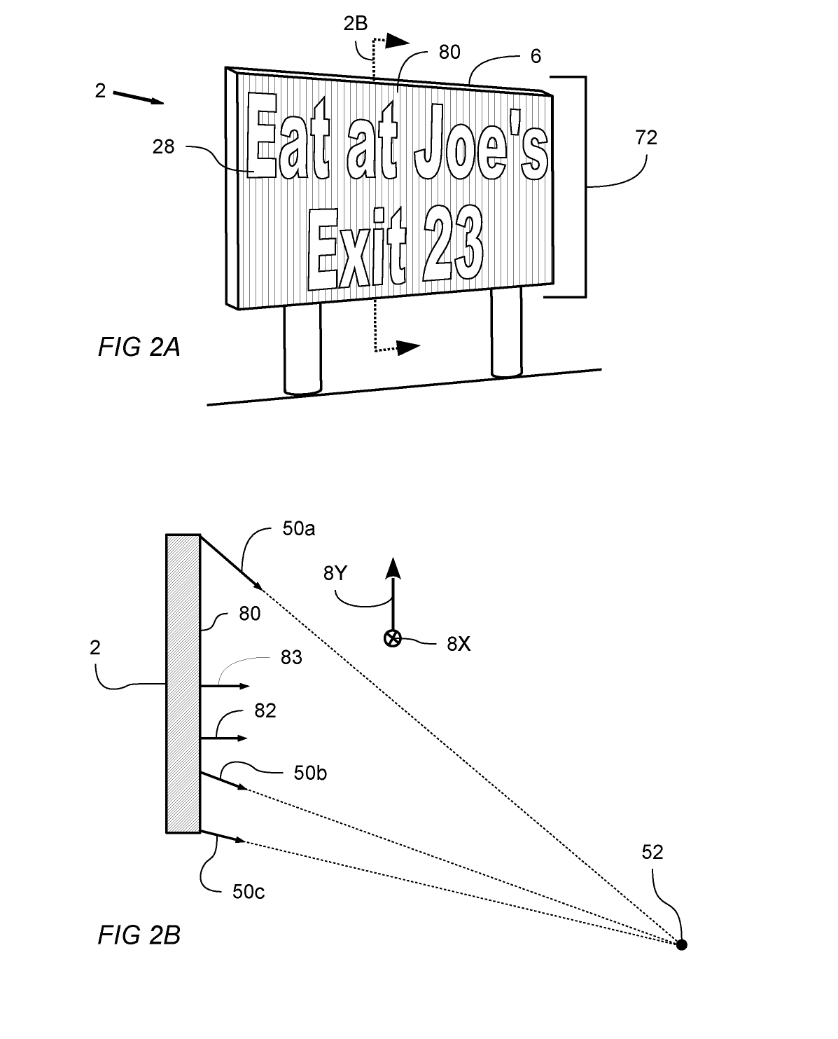

Turning now to FIG. 2A, shown is a representative environment for using display system with directional emission 2. The figure shows a perspective view of a display 4 having a plurality of light emitting elements 72 disposed in a predetermined pattern collectively creating a viewing plane 80. The plurality of light emitting elements may be formed in a predetermined pattern according to any of the teachings of FIG. 1A-FIG. 1H. On the display is shown representative visual media 28 rendered on viewing plane 80. Cross sectional view 2B is indicated in the figure. Associated with the display is display control system 6, which is operative to control the presentation of visual media on the display as well as to control the presentation of calibration patterns. The viewing plane 80 of display 4 in FIG. 2A and FIG. 2B has a predetermined geometric shape. In the embodiment of FIG. 2A and FIG. 2B, the geometric shape creates a rectangular viewing plane 80. Other embodiments may have a viewing plane having a different shape and consequently may have other identifiable geometric features that may be corners, edges, curved shapes or other shapes.

FIG. 2B is the cross sectional view of display system 2 as indicated in FIG. 2A. A person located at viewpoint 52 would see light emitted from viewing plane 80 by display system 2. X-axis 8X and y-axis 8Y are shown in the figure, x-axis 8X corresponding to a horizontal axis with respect to a viewer of the display while y-axis 8Y corresponds to a vertical axis with respect to a viewer. Surface normal vector 82 is perpendicular to the plane containing both x-axis 8X and y-axis 8Y. First, second, and third incidence vectors, 50a, 50b, and 50c respectively, originate from light emitting elements of the display that comprise a portion of the viewing plane. First, second, and third incidence vectors, 50a, 50b, and 50c respectively, converge at viewing point 52, thereby enabling the display to be perceived by a viewer. In the embodiment of FIG. 2B, any light that does not reach even a single viewer of the display may contribute to light pollution and also represents an inefficient use of power. Horizon vector 83 originates at the centroid of the viewing plane and points towards the horizon. In some embodiments, light that is directed above the horizon vector contributes to light pollution.

A viewpoint may be defined anywhere in 3 dimensional space from which the viewing plane is visible. The viewpoint represents a viewer located at that distance looking at the viewing plane. For any given, fixed viewpoint, at each light emitting element an incidence vector may be defined originating at the light emitting element and extending to the viewpoint. For any given, fixed viewpoint, each light emitting element may be expected to emit light along a unique incidence vector, each of which arrives at the viewpoint. It is evident from the geometry that a fixed viewpoint located far away from the viewing plane has the property that each incidence vector is nearly parallel to every other incidence vector. In FIG. 2B first, second, and third incidence vectors 50a, 50b, and 50c, respectively, are consistent with viewpoint 52 that is located close enough to the viewing plane that the incidence vectors are not parallel.

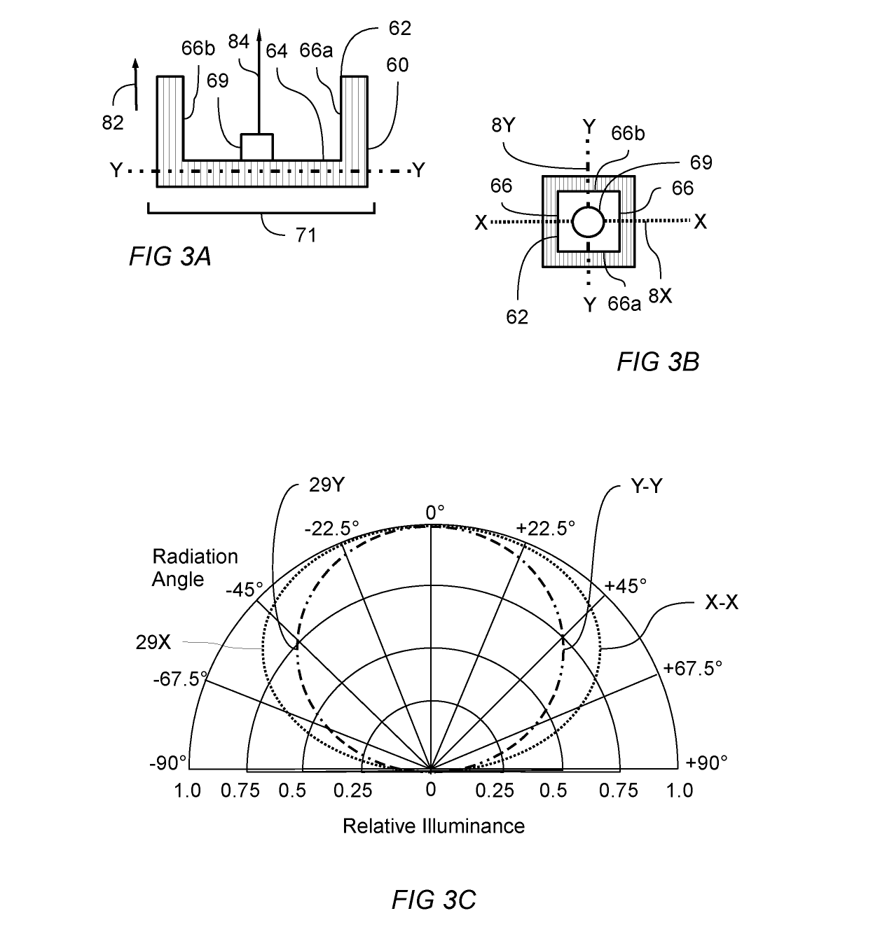

FIG. 3A is a cross-sectional view of a light emitting element 71 without any directional emission features. The vertical axis Y-Y that is shown corresponds to the y-axis of prior FIG. 2B. FIG. 3B is a plan view of the light emitting element of FIG. 3A, both horizontal axis X-X and vertical axis Y-Y being shown. Light emitting element 71 is shown comprising light emitting device 69 disposed within a cavity formed in substrate 60, the cavity being defined by bottom surface 64 and a plurality of wall surfaces 66, which include at least a first wall surface 66a and a second wall surface 66b. Luminous output 84 produced by the light emitting device passes through aperture 62, the aperture being formed by the plurality of wall surfaces 66.

Light emitting element 71 produces luminous output 84 that diverges as it propagates away from the emitter at the speed of light. FIG. 3C presents a graph of relative illuminance versus radiation angle for the representative light emitting element 71 of FIG. 3A and FIG. 3B. The reference designators X-X and Y-Y refer back to the light emitting element of FIG. 3B. 0 degrees on the graph corresponds to a direction that is perpendicular to the 2 dimensional plane containing both X-X and Y-Y axes and hence is parallel to surface normal vector 82. On this graph the maximum illuminance has a value of 1.0, all other values being relative to this maximum. The graph indicates the way in which relative illuminance will diminish as the angle with respect to either the X-X axis or the Y-Y axis moves away from 0 degrees. Far field emission pattern 29X is shown having a substantially symmetric shape about a peak emission angle of approximately 0 degrees. Far field emission pattern 29Y is shown having a substantially symmetric shape about a peak emission angle of approximately 0 degrees.

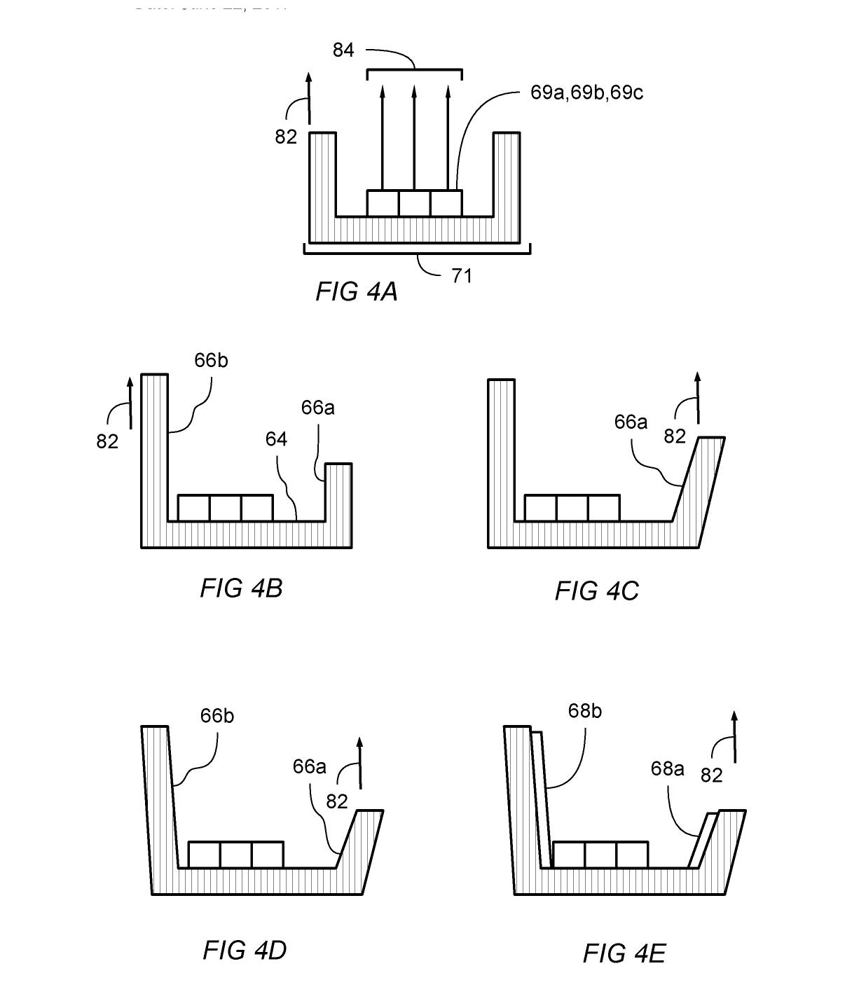

FIG. 4A shows a light emitting element comprising a first, second, and third light emitting devices 69a, 69b, and 69c, respectively. In some embodiments it may be preferred to dispose multiple light emitting devices within a single cavity in light emitting element 71 for the purpose of emitting multiple primary colors, for example, red, green and blue. Similar to the embodiment of FIGS. 3A and 3B, the light emitting element 71 here comprises a plurality of light emitting devices 69a, 69b, and 69c disposed within a cavity formed in substrate, the cavity being defined by a bottom surface and a plurality of wall surfaces. Luminous output 84 produced by the light emitting devices passes through an aperture formed by the plurality of wall surfaces. The FFEP of the light emitting element of configuration of FIG. 4A may be expected to look similar to graph of FIG. 3C, in which the FFEP of the configuration shown in FIG. 4A is essentially the super-position of the FFEP for each individual light emitting element.

Turning now to FIG. 4B, shown is an embodiment of a light emitting element having directional emission features. A plurality of light emitting devices are shown disposed on the bottom wall of a cavity formed in a substrate. The cavity is defined by a bottom surface and a plurality of wall surfaces. The plurality of wall surfaces include at least a first wall surface 66a extending from the bottom surface and a second wall surface extending from the bottom surface. Luminous output leaves the light emitting element through an aperture formed collectively by the plurality of wall surfaces. Second wall surface 66b extends further than first wall surface 66a and thereby influences the direction of emission and intensity of the luminous output thereby changing the FFEP. The longer second wall surface may absorb a portion and redirect another portion of the luminous output that would otherwise leave the light emitting element if the wall surfaces were of the same height. The light emitting devices may be positioned asymmetrically on the bottom surface so that the light emitting devices are closer to one wall surface than to other wall surfaces.

FIG. 4C shows an embodiment similar to that of FIG. 4B, the first wall surface 66a of FIG. 4C being tilted with respected surface normal vector 82. The tilted first wall surface influences the direction of emission and intensity of the luminous output thereby changing the FFEP.

FIG. 4D shows an embodiment similar to that of FIG. 4B and FIG. 4C. First wall surface 66a and second wall surface 66b of FIG. 4D are tilted with respected surface normal vector 82. The tilted first and second wall surfaces influence the direction of emission and intensity of the luminous output thereby changing the FFEP.

FIG. 4E shows an embodiment similar to that of FIG. 4D. First wall surface 66a and second wall surface 66b of FIG. 4E are tilted with respected surface normal vector 82. The tilted first and second wall surfaces influence the direction of emission and intensity of the luminous output thereby changing the FFEP. In addition, first optical coating 68a on first wall surface may further alter the result of luminous output reaching the first wall surface extinguishing and/or reflecting portions of the luminous output reaching that wall surface. Likewise, second optical coating 68b on second wall surface may further alter the result of luminous output reaching the second wall surface extinguishing and/or reflecting portions of the luminous output reaching that wall surface.

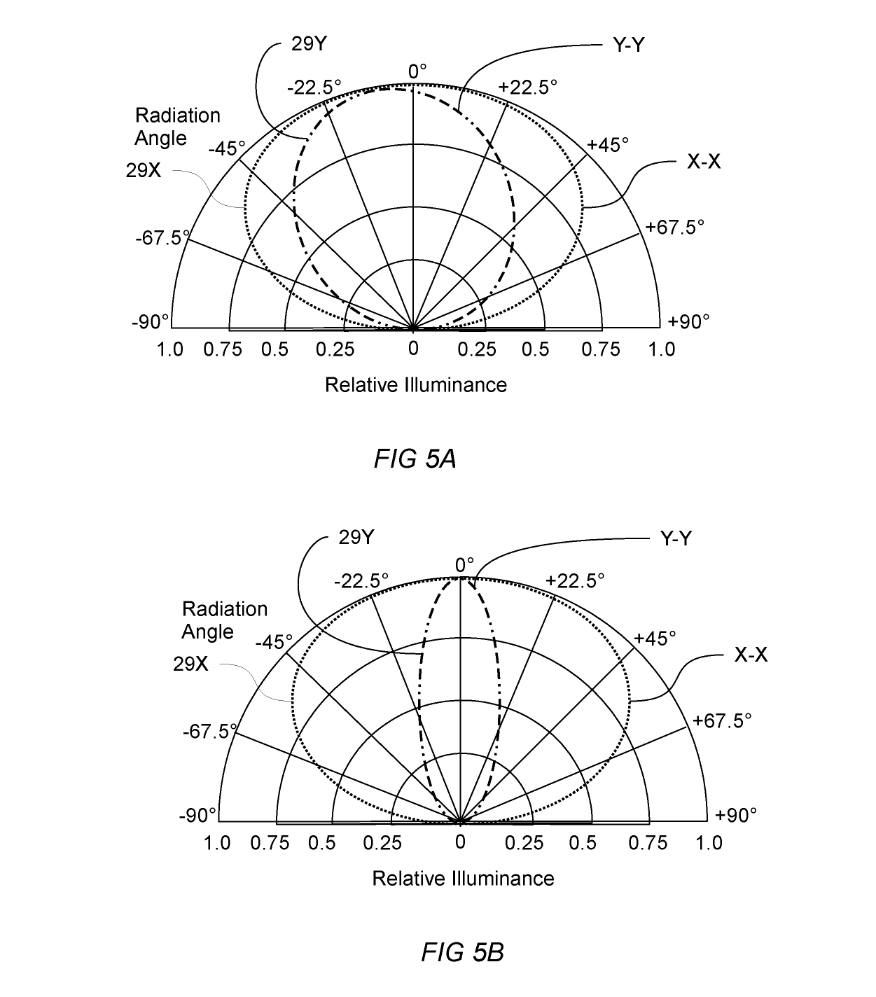

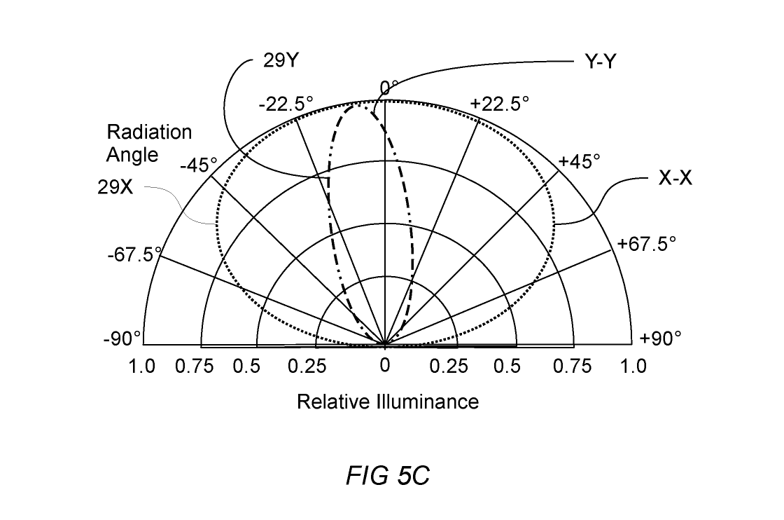

FIG. 5A presents a graph representative of relative illuminance versus radiation angle for the light emitting elements 71 of FIG. 4B-FIG. 4E. The reference designators X-X and Y-Y refer back to the cross section and plan views previously described in connection with FIGS. 3A, 3B and 3C. 0 degrees on the graph corresponds to a direction that is perpendicular to the 2 dimensional plane containing both X-X and Y-Y axes and hence is parallel to surface normal vector 82. On this graph the maximum illuminance has a value of 1.0, all other values being relative to this maximum. The graph indicates the way in which relative illuminance will diminish as the angle with respect to either the X-X axis or the Y-Y axis changes. Far field emission pattern 29X is shown having a substantially symmetric shape about a peak emission angle of approximately 0 degrees. FFEP 29Y is shown having a substantially symmetric shape about a peak emission angle that is substantially different from 0 degrees. The change in FFEP 29Y of FIG. 5A may be noticed by comparison to FIG. 3C. Light emitting systems and devices having the characteristics of FIG. 5A may be described as having directional emission properties as compared to an unmodified display system or an unmodified display device.

FIG. 5B presents a graph representative of relative illuminance versus radiation angle for embodiments of light emitting elements in which, according to FFEP 29Y, optical output is confined in a more narrow band with respect to the Y-Y axis as compared to an unmodified display system or an unmodified display device. FIG. 5C presents a graph representative of relative illuminance versus radiation angle for embodiments of light emitting elements in which, according to FFEP 29Y, optical output is both confined to a more narrow band, and directed such that the peak emission angle is substantially different from 0 degrees. FIG. 5C shows a deflection of the peak emission angle of about 10 degrees from 0. In other embodiments deflection angles of more than about 0 degrees and up to about 10 degrees may be desirable. In other embodiments deflection angles of more than about 10 degrees and up to 45 degrees may be desirable.

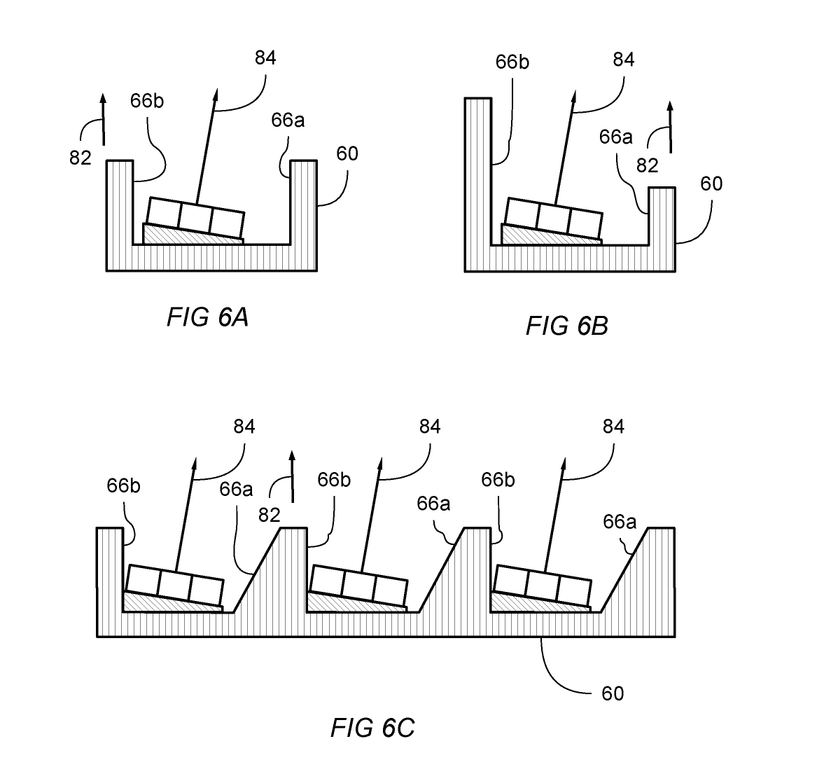

Turning now to FIG. 6A-FIG. 6C, shown are additional embodiments of display apparatus with directional emissions. FIG. 6A shows a plurality of light emitting devices disposed within a cavity in a substrate, the cavity being defined by a bottom surface and a plurality of wall surfaces. The light emitting devices are coupled to the bottom wall such that the emission axis of each light emitting device is at a non-zero tilt angle with respect to the surface normal vector 82 of the display. The non-zero tilt angle provides directional emission.

Turning now to the embodiment FIG. 6B, shown is an embodiment of a light emitting element having directional emission features. A plurality of light emitting devices are shown disposed on the bottom wall of a cavity formed in a substrate. The cavity is defined by a bottom surface and a plurality of wall surfaces. The plurality of wall surfaces include at least a first wall surface extending from the bottom surface and a second wall surface extending from the bottom surface. A plurality of light emitting devices is coupled to the bottom wall such that the emission axis of each light emitting device is at a non-zero tilt angle with respect to the surface normal vector 82 of the display. Luminous output leaves the light emitting element through an aperture formed collectively by the plurality of wall surfaces. Second wall surface 66b extends further than first wall surface 66a and thereby influences the direction of emission and intensity of the luminous output thereby changing the FFEP. The longer second wall surface may absorb a portion and redirect another portion of the luminous output that would otherwise leave the light emitting element if the wall surfaces were of the same height. The light emitting devices may be positioned asymmetrically on the bottom surface so that the light emitting devices are closer to one wall surface than to other wall surfaces. Optical coatings may be used on one or more wall surfaces to control luminous output that strikes said one or more wall surfaces respectively.

According to the embodiment of FIG. 6C, multiple light emitting elements with directional emission features may be formed on a substrate to yield a plurality of light emitting elements having a FFEP that is a composite of the FFEP for each individual light emitting element in the plurality. Each light emitting element of FIG. 6C comprises a plurality of light emitting devices disposed on the bottom wall of a cavity formed in a substrate. Each cavity is defined by a bottom surface and a plurality of wall surfaces. The plurality of wall surfaces pertaining to each cavity includes at least a first wall surface extending from the bottom surface at an angle with respect to the surface normal vector of the display and a second wall surface extending from the bottom surface. A plurality of light emitting devices is coupled to the bottom wall of each cavity such that the direction of peak emission of luminous output corresponding to each light emitting device is at a non-zero tilt angle with respect to the surface normal vector 82 of the display. Luminous output leaves the light emitting element through an aperture formed collectively by the plurality of wall surfaces of each cavity. Optical coatings may be used on one or more wall surfaces to control luminous output that strikes said one or more wall surfaces respectively. The light emitting devices within each cavity may be disposed closer to one wall surface than to others. The overall FFEP of the apparatus of FIG. 6C may be expected to look similar to FIG. 5A.

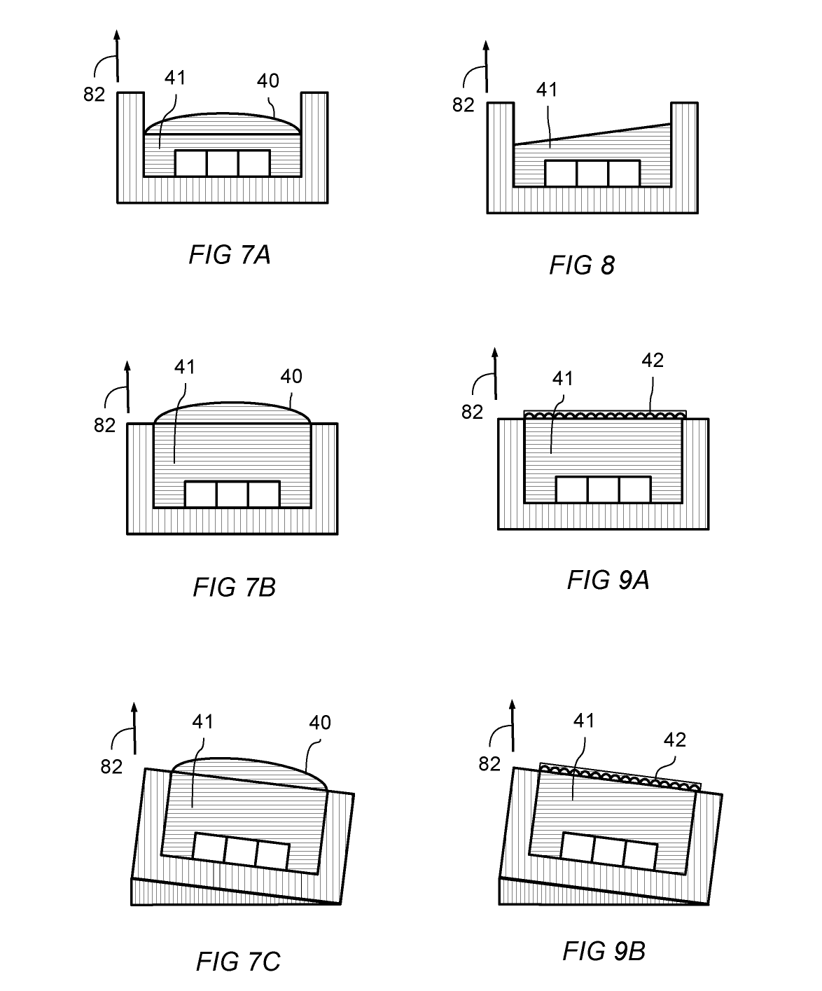

Turning now to FIG. 7A-FIG. 7C, shown are various embodiments of apparatus providing directional emission to light emitting elements. In comparison to prior embodiments, the embodiments shown in FIG. 7A-FIG. 7C additionally comprise a lens shaped element optically coupled to the plurality of light emitting devices through an optical material that at least partially fills the cavity defined by the plurality of wall surfaces in conjunction with the bottom surface. The lens shaped element has the advantage of being able to provide optical gain compared to unlensed embodiment. The effect of the lens shaped element is to provide a more focused and higher intensity illuminance from the light emitting element. The effect of the lens shaped elements on the embodiments of FIG. 7A and FIG. 7B may be better understood by reference to the relative illuminance graph of FIG. 5B, which indicates an FFEP along the Y-Y axis as having a narrower angular range than the baseline graph of FIG. 5A. In FIG. 7C a plurality of light emitting devices is shown disposed within a cavity in a substrate, the cavity being defined by a bottom surface and a plurality of wall surfaces. The light emitting devices are coupled to the bottom wall such that the peak emission axis 84 of each light emitting device is at a non-zero tilt angle with respect to the surface normal vector 82 of the display. The non-zero tilt angle provides directional emission. The apparatus of FIG. 7C may be expected to produce a relative illuminance graph corresponding to FIG. 5C in which the radiation angle of peak emission is substantially non-zero.

FIG. 8 shows an embodiment in which an optical material partially fills the cavity. The optical material has a surface that is angled so that, operating by refraction, the angle of peak emission of the luminous output from the plurality of light emitting devices is turned away from being parallel with surface normal vector 82. Directional emission is thereby produced. The apparatus of FIG. 8 may be combined with other directional emission features of the present disclosure to control directional emissions. The apparatus of FIG. 8 may be expected to produce a relative illuminance graph corresponding to FIG. 5A in which the radiation angle of peak emission is substantially non-zero.

Turning now to FIG. 9A and FIG. 9B, shown are embodiments of apparatus with directional emission in which a microlens array is optically coupled to one or more light emitting devices through an optical material. The micro lens array is effective to provide a more focused and higher intensity illuminance from the light emitting element. The effect of the micro lens elements on the embodiment of FIG. 9A may be better understood by reference to the relative illuminance graph of FIG. 5B, which indicates an FFEP along the Y-Y axis as having a narrower angular range than the baseline graph of FIG. 5A. The embodiment of FIG. 9B features a tilt angle between the direction of peak emission and the surface normal vector. The effect of the micro lens elements on the embodiment of FIG. 9B may be better understood by reference to the relative illuminance graph of FIG. 5C, which indicates an FFEP along the Y-Y axis as having a narrower angular range than the baseline graph of FIG. 5A. Furthermore, the angle of peak emission produced in the FFEP is substantially non-zero according to the graph of FIG. 5C.

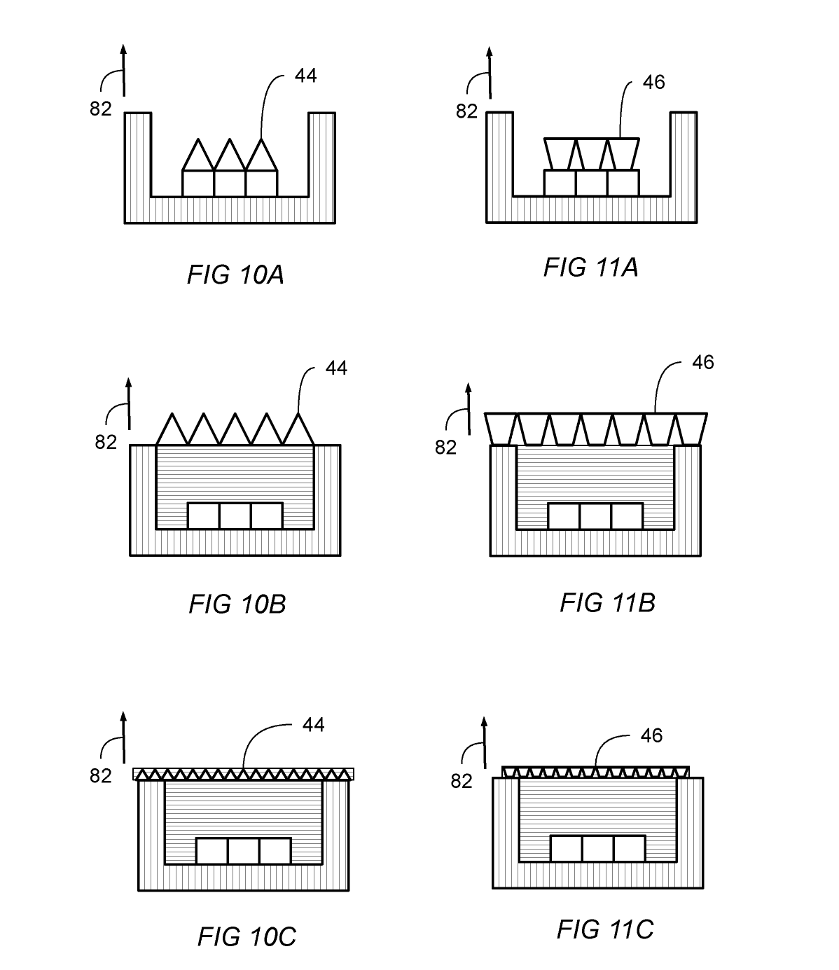

Shown in FIG. 10A-FIG. 10C are a series of embodiments in which an array of prismatic optical elements 44 are optically coupled to one or more light emitting devices and make use of total-internal-reflection and refraction properties to confine the emitted light to a narrow angular range, thereby providing directional emission with light gain. The effect of the array of prismatic optical elements 46 on the embodiment of FIG. 10A-FIG. 10C may be better understood by reference to the relative illuminance graph of FIG. 5B, which indicates an FFEP along the Y-Y axis as having a narrower angular range than the baseline graph of FIG. 5A.

Shown in FIG. 11A-FIG. 11C are a series of embodiments in which an array of total internal reflection (TIR) optical elements 46 are optically coupled to one or more light emitting devices and make use of TIR and refraction properties to confine the emitted light to a narrow angular range, thereby providing directional emission with light gain. The effect of array of TIR optical elements 46 on the embodiment of FIG. 11A-FIG. 11C may be better understood by reference to the relative illuminance graph of FIG. 5B, which indicates an FFEP along the Y-Y axis as having a narrower angular range than the baseline graph of FIG. 5A.

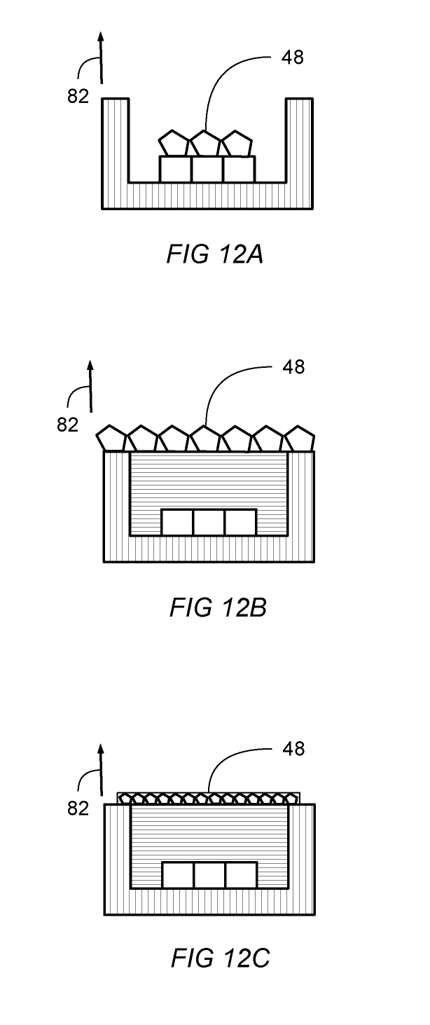

FIG. 12A-FIG. 12C show various embodiments in which one or more asymmetric pentagonal lens elements in an array 48 are optically coupled to the light emitting elements and are effective for both confining the emitted light to a more narrow range and changing the direction of peak emission, thereby providing directional emission with light gain. The embodiments of FIG. 12A-FIG. 12C features a tilt angle between the direction of peak emission and the surface normal vector 82. The effect of the asymmetric pentagonal lens element on the embodiments of FIG. 12A-FIG. 12C may be better understood by reference to the relative illuminance graph of FIG. 5C, which indicates an FFEP along the Y-Y axis as having a narrower angular range than the baseline graph of FIG. 5A. Furthermore, the angle of peak emission produced in the FFEP is substantially non-zero according to the graph of FIG. 5C.

Although the present invention has been described in considerable detail with reference to certain preferred versions thereof, other versions are possible. It may be desirable to combine features shown in various embodiments into a single embodiment. A different number and configuration of features may be used to construct embodiments of the apparatus and systems that are entirely within the spirit and scope of the present disclosure. Therefor, the spirit and scope of the appended claims should not be limited to the description of the preferred versions contained herein.

Any element in a claim that does not explicitly state “means for” performing a specified function, or “step for” performing a specific function, is not to be interpreted as a “means” or “step” clause as specified in 35 U.S.C. Section 112, Paragraph 6. In particular, the use of “step of” in the claims herein is not intended to invoke the provisions of 35 U.S.C. Section 112, Paragraph 6.

What is claimed is:

1. A light emitting display system comprising:
a) a plurality of light emitting elements arranged in a predetermined pattern collectively defining a viewing plane;
b) each of said plurality of light emitting elements comprising:
i) at least one light emitting device having a first far field emission pattern of optical power, the light emitting device producing an emitted light;
A) said first far field emission pattern having a first direction along which a first peak intensity of optical power of said first far field emission pattern propagates;
ii) an optical element optically coupled to said light emitting device, at least a portion of said emitted light passing through said optical element, said optical element operative to transform said first far field emission pattern into a second far field emission pattern of optical power, said second far field emission pattern having a second direction along which a second peak intensity of optical power of said second far field emission pattern propagates;
iii) further characterized in that said first direction and said second direction are not parallel;
iv) further characterized in that said second peak intensity is higher than said first peak intensity;
c) said plurality of light emitting elements collectively creating, by superposition of each of said second far field emission patterns, a third far field emission pattern of optical power emitted by the light emitting display system, said third far field emission pattern having a third direction along which a third peak intensity of optical power of said third far field emission pattern propagates;
d) the viewing plane further defining a surface normal vector that is perpendicular to said viewing plane;
e) the system further characterized in that said third direction and said surface normal vector are not parallel.

2. The system of claim 1 further characterized in that:
a) a horizon vector is defined originating at the geometric centroid of the viewing plane and directed toward the horizon;
b) said third direction is in a direction that is below the horizon.

3. The system of claim 1 further characterized in that:
a) the third far field emission pattern has a left-right mirror symmetry with respect to a vertical plane defined perpendicular to the viewing plane and passing through the geometric centroid of the viewing plane.

4. The system of claim 1 further characterized in that:
a) the third far field emission pattern does not have up-down mirror symmetry with respect to a horizontal plane defined perpendicular to the viewing plane and passing through the geometric centroid of the viewing plane.

5. The system of claim 1 further characterized in that the optical element is a lens.

6. The system of claim 1 further characterized in that the optical element is a plurality of lenses.

7. The system of claim 1 further characterized in that the optical element is microlens array.

8. The system of claim 1 further characterized in that the optical element is a TIR lens.

9. The system of claim 1 further characterized in that:
a) each of said plurality of light emitting elements comprises a plurality of light emitting devices disposed within a cavity formed in a substrate, the cavity being defined by a bottom surface and a plurality of wall surfaces; each of the light emitting devices emitting light;
b) the first far field emission pattern comprises a superposition of the far field emission pattern from each of the plurality of light emitting devices after the emitted light passes through an aperture formed by the plurality of wall surfaces;
c) the optical element further characterized in that it is disposed to receive at least a portion of light emitted from each of said plurality of light emitting devices.

10. The system of claim 9 in which the optical element is disposed in contact with said aperture.

11. The system of claim 9 in which the optical element is disposed within said cavity.

12. The system of claim 9 in which the optical element is disposed within said aperture.
